(19) United States
(12) Patent Application Publication
(10) Pub. No.: US 2004/0046747 A1
(43) Pub. Date: Mar. 11, 2004

(54) Providing input signals

(76) Inventor: Eugenio Bustamante, East Sussex (GB)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/381,640

(22) PCT Filed: Sep. 26, 2001
(86) PCT No.: PCT/GB01/04282

(30) Foreign Application Priority Data
Sep. 26, 2000 (GB) 0023502.8
May 26, 2001 (GB) 0112883.4

(51) Int. Cl. G09G 5/00

(52) U.S. Cl. 345/173

(57) ABSTRACT

Apparatus for providing input signals to a device such as a computer (1) to be controlled by a n operator comprises means (3) for generating a virtual image (2) of an interface tot he device to be controlled, means (5) for detecting the position of an operating member (4) actuated by the operator, and means (6, 7, 3) for generating a virtual image (8) of the operating member (4), the arrangement being such that movement of the operating member image (8) in accordance with movement of the operating member (4) interacts with the interface image (2) to provide the input signals for the device. A method of providing the input signals is also disclosed. The detecting means (5) preferably comprises a stereoscopic image generator, while the means for generating the virtual images includes a virtual environment processor (3). The advantage of the apparatus and method lies in its ease of use, as the operating member can be held in a comfortable position.

This invention relates to apparatus for providing input signals to a device to be controlled by an operator, and to a method of providing the input signals.

Normally, input signals to a device such as a personal computer or other electronic device are provided by the operator touching an input device such as a keyboard, mouse, touch screen or the like. The computer usually has a monitor or other display on which the output is displayed. The monitor may in some circumstances be used as a touch screen to provide the input signals as well. Typically, the monitor and input device for a personal computer take up a lot of space. Also, it can be difficult for disabled users to operate the standard input devices. It has been proposed to provide a holographic image as an input device. The operator touches the image to provide an input signal, and the touch is detected optically. While this removes the need for a physical keyboard or mouse, it can be difficult for the operator to know when the image has actually been touched.

GB-A-2 345 538 shows the use of a video camera to track a user's hand or other body part. The position and orientation of the hand are then analysed by a computer, and used to control the computer. It is important to be able to detect accurately the position of the hand in 3 dimensions for full control. However, it is difficult to do this with a video camera, as it has been found that small movements towards and away from the camera are difficult to detect precisely.

According to a first aspect of the present invention, apparatus for providing input signals to a device to be controlled by an operator comprises means for generating a virtual image of an interface to the device to be controlled, means for detecting the position of an operating member actuated by the operator, and means for generating a virtual image of the operating member, the arrangement being such that movement of the operating member image in accordance with movement of the operating member interacts with the interface image to provide the input signals for the device.

Thus, in the first aspect of the invention the device interface is provided as a virtual image, and the virtual image of the operating member, rather than the operating member itself, interacts with the interface image to provide the input signal. The interface image may include the monitor display and possibly the keyboard or other input device, so that the monitor and the input devices do not need to be provided physically. The apparatus is easy to use, as it is not necessary for the operator to physically touch an image, but instead the operator controls a virtual image of the operating member. This means that the operator can hold the operating member in a comfortable position for use. It makes the invention particularly suitable for disabled users as the operating member can be used to provide the full range of input signals easily.

Preferably the means for generating the virtual image of the interface comprises a virtual environment processor means. This may be incorporated in the device as hardware or software, or a combination. The virtual image is a three-dimensional image.

the operating member may comprise the operator's hand, or a suitable tool such as a stylus or pointer adapted to be held in the hand or other part of the operator's body. A stylus may be particularly suitable for disabled users.

The means for detecting the position of the operating member may comprise a stereoscopic image generator. This provides a particularly accurate way of detecting the position of the operating member. Any known means for acquiring the stereoscopic image may be used. The preferred means comprises of a pair of pinhole cameras whose optical properties are known or can be calculated.

The data from the stereoscopic pairs of images are preferably passed to an image preparation means, which forms part of the means for generating the virtual image of the operating member. The image preparation means may be executed as hardware or software. It manipulates the stereo data to be more useful for the next part of the means for generating a virtual image of the operating member.

The means for generating a virtual image of the operating member preferably includes a signal generator, which generates signals indicating the three-dimensional co-ordinates of the operating member using the stereo data. The signal generator conveniently uses extrapolation functions to determine the three-dimensional co-ordinates from the stereo data. The extrapolation functions may be performed by hardware or software.

The three-dimensional co-ordinate signals are passed to the virtual environment processor means to complete the generation of the virtual image of the operating member. The virtual environment processor means combines the image of the interface with the image of the operating member for the user. It also provides input signals for the device in accordance with the interaction of the operating member image with the interface image. The virtual environment processor means may in effect act as the operating system for the device.

The virtual environment processing means may generate and operate virtual images of any required input device, such as a keyboard (in any given language), a joystick, a mouse or a remote control keypad.

The device may then include an application programming interface, to allow other application programs to act in the virtual environment processor means. For example, standard word processing or database applications could be run through the virtual environment processor means.

The virtual environment processor means may also provide output signals for an output display such as a monitor, TV or head-up display. It may also generate output signals to control an external device, such as a video recorder. This obviates the need for a physical remote control device for the external device.

According to a second aspect of the invention, a method of providing input signals to a device to be controlled by an operator comprises:

generating a virtual image of an interface to the device to be controlled;

detecting the position of an operating member actuated by the operator;

generating a virtual image of the operating member;

relating the virtual image of the operating member to the virtual image of the interface such that movement of the operating member image in accordance with movement of the operating member interacts with the interface image; and

providing input signals for the device from the interaction of the operating member image and the interface image.

As indicated above, this method provides a way of generating input signals by using virtual images rather than hardware, and is easy to use.

Generation of the interface image is preferably performed by a virtual environment processor means. This produces a three-dimensional image of the interface, for example of a monitor display and possibly an input device such as a keyboard.

Detection of the position of the operating member is preferably performed by a stereoscopic image generator. This produces stereo data enabling the exact position of the operating member to be calculated.

The data may be manipulated by an image preparation means, as the first part of generation of the operating member image. The next part of this is performed by a signal generator, which generates signals indicating the three-dimensional co-ordination of the operating member from the stereo data, and by the virtual environment processor means, using the three-dimensional co-ordinates.

Relating the operating member image to the interface image is also performed by the virtual environment processor means, as is the production of the input signals for the device.

The virtual environment processor means may accept signals from external devices or programs to enable these to be operated in the interface image.

The virtual environment processor means may also provide output signals for displays or to control external devices.

According to a third aspect of the present invention, apparatus for providing input signals to a device to be controlled by an operator comprises means for optically detecting the position of an operating member actuated by the operator in a control space corresponding to an input device of the device to be controlled, movement of the operating member in the control space being represented on an output device and providing input signals for the device, and the means for detecting the position of the operating member comprising a stereoscopic image generator.

Thus, the movement of the operating member in the control space, as well as providing the input signals, is also represented on the output display, providing feedback to the operator as to how the movements are interpreted by the device to be controlled. The apparatus is therefore easy to use, as it is not necessary for the operator to physically touch an image, but instead can simply move the operating member in the control space, and see (or otherwise sense) how the movement is interpreted. This means that the operator can hold the operating member in a comfortable position for use. It makes the invention particularly suitable for disabled users as the operating member can be used to provide the full range of input signals easily. Further, a conventional input device is not required, being replaced by the operating member. The stereoscopic image generator provides a particularly accurate way of detecting the position of the operating member in 3 dimensions, making it possible to use the operating member to control the device.

The operating member may comprise the operator's hand, or suitable tool such as a stylus or pointer adapted to be held in the hand or other part of the operator's body. A stylus may be particularly suitable for disabled users.

The stereoscopic image generator preferably comprises a pair of pinhole cameras whose optical properties are known or can be calculated.

The data from the stereoscopic pairs of images are preferably passed to an image preparation means to manipulate the stereo data. This may be executed as hardware or software.

The image preparation means passes the data to a signal generator, which generates signals indicating the three-dimensional co-ordinates of the operating member using the stereo data. The signal generator conveniently uses extrapolation functions to determine the three-dimensional co-ordinates from the stereo data. The extrapolation functions may be performed by hardware or software. The signals from the signal generator then provide the input signals for the device to be controlled.

In its simplest form, movement of the operating member in the control space provides the input signals to the device directly. The operating member then acts like a mouse for a personal computer or a remote control for a digital television receiver, or DVD player. The movement is represented on the output display such as a screen, as movement of a cursor or as a display or in any other suitable way.

The stereoscopic image generator, the image preparation means and the signal generator may then conveniently be combined in a single unit, separate from the device to be controlled. The input signals are relayed from the unit to the device being controlled by any suitable means such as wires, or infra-red or other appropriate wireless protocols.

Alternatively, the stereoscopic image generator, the image preparation means and the signal generator may be incorporated into the device to be controlled.

The output display is preferably visual, and may be real (as a monitor or television screen).

The apparatus or the device may include an application programming interface to allow application programs to operate on the device. For example, if the device being controlled is a digital television receiver, the apparatus may include a program allowing the operator to use the operating member to draw pictures on the screen, in a similar way to the Microsoft “paint” program, used on a personal computer.

According to a fourth aspect of the invention, a method of providing input signals to a device to be controlled by an operator comprises:

defining a control space corresponding to an input device of the device to be controlled;

optically detecting by means of a stereoscopic image generator the position of an operating member actuated by the operator in the control space;

providing input signals for the device from the movement of the operating member in the control space; and

representing movement of the operating member in the control space on an output device of the device to be controlled.

As indicated above, this method provides a way of generating input signals by optically detecting movement by a stereoscopic image generator of an operating member in a control space, rather than using a physical input device and is easy to use. The stereoscopic image generator produces stereo data enabling the exact position of the operating member to be calculated.

Providing the input signals is performed by manipulation of the data by an image preparation means, and by a signal generator, which generates signals indicating the three-dimensional co-ordinates of the operating member from the stereo data.

Representing the movement of the operating member on the output device is preferably performed as movement of a cursor on a display screen.

Embodiments of the various aspects of the invention are illustrated by way of example in the accompanying drawings, in which:

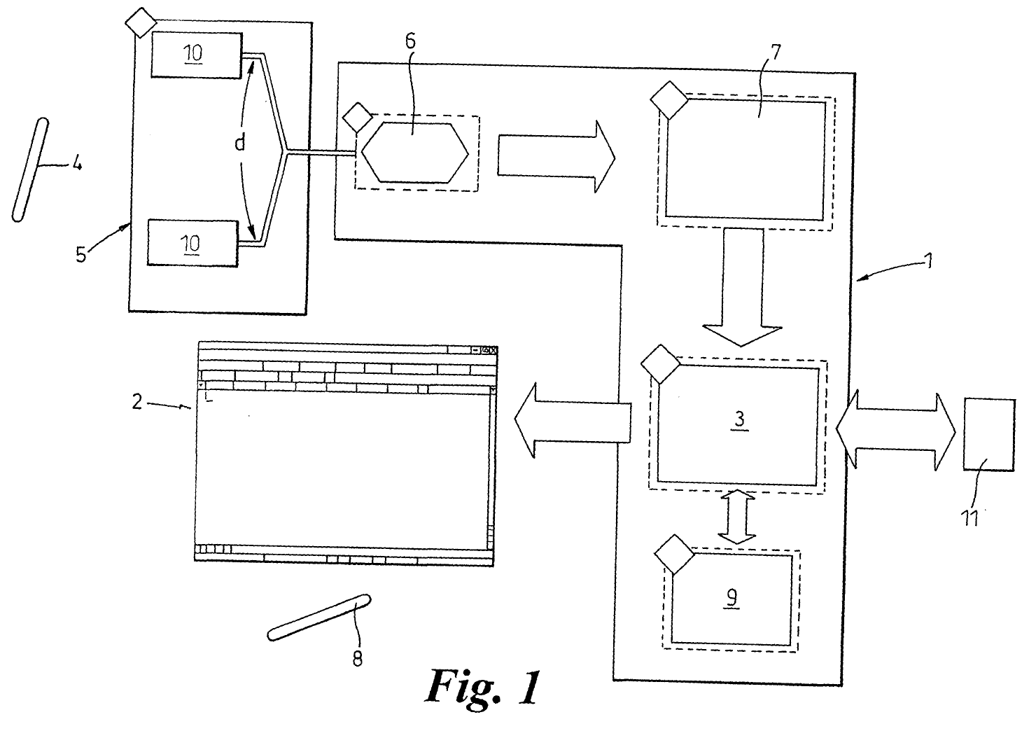

FIG. 1 is a block diagram showing the apparatus for providing input signals to a personal computer;

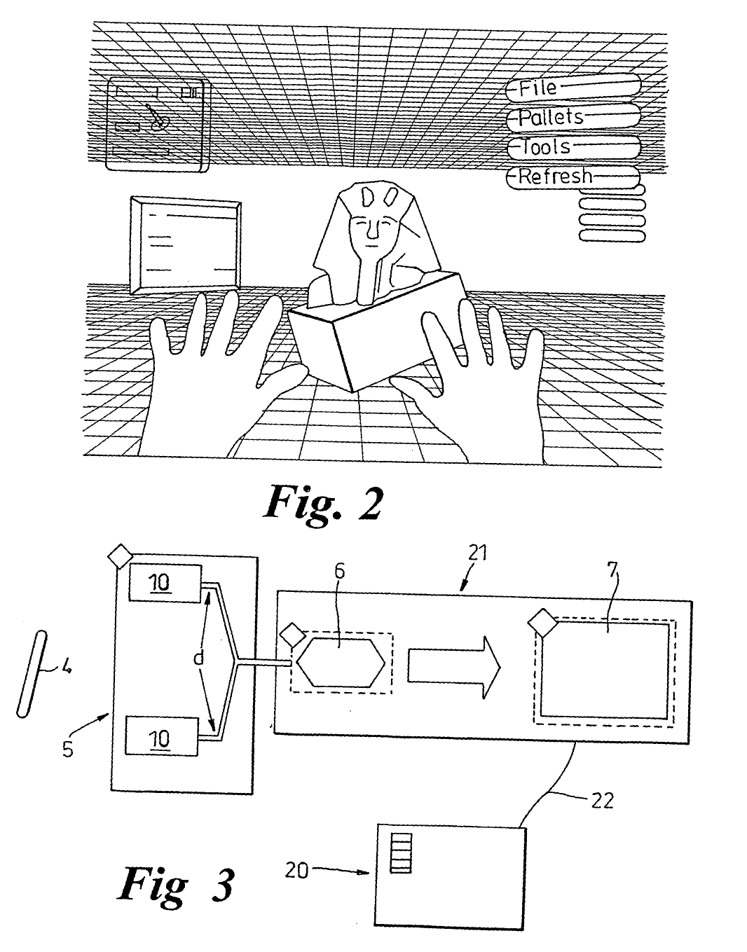

FIG. 2 is an illustration of the virtual image used for generating the input signals; and

FIG. 3 is a block diagram showing modified apparatus for providing input signals to a digital television receiver.

FIG. 1 shows in diagrammatic form an apparatus for providing input signals from an operator (not shown) to a computer 1. Most of the apparatus is actually incorporated in the computer processor unit.

The apparatus includes a means for generating a three-dimensional virtual image 2 of an interface to the computer 1 comprising a virtual environment processor 3 which forms part of the processor unit of the computer 1. The apparatus also has a means for detecting the position of an operating member 4 actuated by the operator, comprising a stereoscopic image generator 5. The operating member 4 as shown comprises a stylus, but it could equally well be the operator's hand or hands. The apparatus further includes means generating a virtual image of the operating member 4 comprising an image preparation means 6, signal generating means 7 and the virtual environment processor 3. The image preparation means 6 and signal generating means 7 may be hardware, software or a combination, and here are both incorporated into the computer processor unit, although they may be separate from it. The image preparation means 6 manipulates data from the stereoscopic image generator 5, and passes it to the signal generating means 7, which extrapolates it into three-dimensional co-ordinates used by the virtual environment processor 3 to create the virtual image 8 of the operating member 4. The virtual environment processor 3 also combines the operating member image 8 with the interface image 2, and processes the interaction of the two images 8, 2 to provide input signals for the computer 1. FIG. 2 shows the combined images, where the operating member 4 comprises the operator's hands.

The apparatus also includes an application programming interface 9 which interacts with the virtual environment processor 3, and external devices 11 which also interact with the virtual environment processor 3. As will be explained in more detail later, these are optional features.

The virtual environment processor 3 is a combination of hardware and software, and in the embodiment described actually acts as the main operating system of the computer 1. The virtual environment processor 3 generates the virtual image of a display, such as a screen, as shown in FIG. 2, as a three-dimensional environment with perspective effects. It may also generate a virtual image of any standard type of physical input device, such as a keyboard, a mouse, a joystick or other keypad.

Actuation of the virtual image of the input device or of elements of the virtual display by the virtual image of the operating member 4 is detected by the virtual environment processor 3, which then signals the computer 1 to perform the required operation.

The stereoscopic image generator 5 may be of any known type. It will be placed at approximately the height of the operator's hands. Typically, the image generator 5 is wide-angle, and has a pair of lenses of known focal properties separated by a known distance d (which may be measured or calculated). The lenses produce a pair of stereoscopic images 10, which are passed to the image preparation means 6 for the data to be manipulated. It will be appreciated that the stereoscopic image generator will usually be a stereoscopic pinhole camera as described, but that a single lens with two pinholes could be used.

The image preparation means 6 performs a correspondence function, by finding for each point on one stereoscopic image of the pair of corresponding point on the other, and computing the disparity of these points. The image preparation means 6 constructs a disparity map for each pair of stereoscopic images, forming stereo data that is passed to the signal generating means 7.

The signal generating means 7 takes the disparity map, the focal distance of the lenses and the geometry of the stereo setting, that is, the relative position and orientation of the lenses, and computes the three-dimensional Cartesian co-ordinates (x,y,z) of all the points in the stereoscopic image pair. The co-ordinates are then passed to the virtual environment processor 3 to complete the generation of the virtual image of the operating member 4.

The application programming interface 9 interacts with the virtual environment processor 3 acting as the computer operating system. The interface 9 enables standard application programs, such as for example word processing, database, spreadsheet or e-mail packages to be run through the virtual environment processor 3, so that they can be operated using the virtual images 8, 2.

The external device 11, for example a video recorder, can also be operated from the virtual environment processor 3. Thus, if the remote control keypad of the video recorder is created as a virtual image by the virtual environment processor 3, on operation of the keypad by the operating member image 8, the processor 3 generates appropriate output signal to operate the video recorder. Before using the apparatus it will normally be necessary to calibrate the system to the operator's hands and/or any other operating member 4. A standard stylus may be used to assist in the calibration, which includes calibration of colour, the size of the operator's hand and definition of an active area.

Thus, a calibration routine would be as follows:

showing of the stylus, which is of known size, to allow relative scale to be determined;

showing the palm of the hand to the camera, to allow determination of the colour and luminance of the palm of the operator's hand;

turning of the hand to the colour and luminance of the back of the hand. If the values for the palm and the back of the hand are outside a given range the system will not operate properly, and lighting conditions will need to be altered, or gloves worn to enable operation to continue; defining the primary activation digit, which the apparatus considers first in trying to define a movement of the operator's hand; and

using the primary activation digit to draw a floating rectangle, to define the active area. The system only responds to gestures within this area, so that other movements, which are not intended to operate the computer 1, are not recognised by the apparatus as commands to the apparatus.

Once the calibration is complete, the virtual environment processor 3 presents the virtual images 2 and 8 to the operator (as in FIG. 2). Movement of the hands or stylus is reflected in the virtual image, so that interaction of the virtual hands with objects in the interface image 2 is possible.

The virtual environment processor 3 may generate the images of input devices for interaction. The hand or stylus could replace the need for a mouse, as the primary activation digit could be used as a pointer, and as a mouse click device. In fact, hand or stylus gestures such as pointing, pushing or pulling can be used to select objects, such as windows, menus or the like. For example, in FIG. 2, the floating file menu could be selected by pointing, and it would change colour to indicate selection. The primary actuation digit could be used to press a selection button on a menu.

The main advantage of the apparatus and the method it uses is that physical input devices are no longer needed, thus saving space. It also has advantages for use by disabled operators, who can use the virtual image system to replicate all the functions performed by non-disabled users. A disabled operator could use the stylus held in the hand, foot or mouth, to operate the computer 1 fully and easily.

FIG. 3 shows a modification of the apparatus, to provide input signals from an operator (not shown) to a digital television receiver 20. This apparatus is a simplified version of that shown in FIG. 1, as the virtual environment processor is omitted. Corresponding reference numerals have been applied to corresponding parts.

In FIG. 3 the television receiver 20 is separate from the apparatus, which comprises the stereoscopic image generator 5, the image preparation means 6 and the signal generator 7. These are all combined in a single unit 21, connected to the receiver 20 by wires 22.

As in FIG. 1, the operating member 4 comprises a stylus, moving a control space corresponding to an input device such as a remote control. The movement is detected as before by the stereoscopic image generator 5, and the stereo data manipulated by the image preparation means 6. The signal generator 7 extrapolates the stereo data into three-dimensional co-ordinates, which are processed to form input signals for the receiver 20.

The signal generator 7 provides the input signals directly to the television receiver 20 via the wires 22, although infra-red or other wireless protocols may be used instead.

The receiver 20 produces a display on the television screen as though the remote control input device had been used. Movement of the operating member 4 changes the display, so that the operator can see how the movements are interpreted. For example, the display may produce menus, items from which can be highlighted by movement of the operating member 4, and selected by movement towards the detector, as though to “click” on a button.

As with FIG. 1, a calibration routine would be necessary to set up operation.

The apparatus may also include an application program operated by the operating member, for display on the television screen. For example, the program may allow the operator to “draw” on the screen (using the remote operating member) to create pictures.

In a modification (not shown) the simplified apparatus of FIG. 3 is also used with a conventional personal computer with keyboard and monitor display, with the operating member 4 replacing the standard mouse input device. The operator instead wears a suitable thimble on one finger, and when not using the keyboard this finger can be held up in order to control the computer. The apparatus in this case interprets the movement of the finger with the thimble as a movement of a mouse, to move the cursor and act as an input device. The thimble is of a material with low reflective properties, and may be coloured as appropriate. It may even be two-tone to provide appropriate contrast for the detector.

This embodiment is advantageous as it means that the operator does not need to use a mouse, but can still control the computer by using a single digit.

1. Apparatus for providing input signals to a device (1) to be controlled by an operator comprises means (3) for generating a virtual image (2) of an interface to the device to be controlled, means (5) for detecting the position of an operating member (4) actuated by the operator, and means (6, 7, 3) for generating a virtual image (8) of the operating member, the arrangement being such that movement of the operating member image (8) in accordance with movement of the operating member (4) interacts with the interface image (2) to provide the input signals for the device.

2. Apparatus as claimed in claim 1, in which the means for generating the virtual image of the interface comprises a virtual environment processor means (3).

3. Apparatus as claimed in claim 1 or claim 2, in which the operating member (4) comprises the operator's hand.

4. Apparatus as claimed in claim 1 or claim 2, in which the operating member (4) comprises a tool such as a stylus or pointer adapted to be held in the hand or other part of the operator's body.

5. Apparatus as claimed in any preceding claim, in which the means for detecting the position of the operating member comprises a stereoscopic image generator (5).

6. Apparatus as claimed in claim 5, in which the stereoscopic image generator (5) comprises a pair of pinhole cameras whose optical properties are known or can be calculated.

7. Apparatus as claimed in claim 5 or claim 6, in which the means for generating the virtual image of the operating member includes an image preparation means (6), to which the data from the stereoscopic pairs of images are passed to manipulate the stereo data.

8. Apparatus as claimed in claim 7, in which the means for generating the virtual image of the operating member includes a signal generator (7), to which data from the image preparation means (6) is passed to generate signals indicating the three-dimensional co-ordinates of the operating member (4) using the stereo data.

9. Apparatus as claimed in claim 8, in which the virtual environment processor means (3) receives the three-dimensional co-ordinate signals from the signal generator (7), to complete the generation of the virtual image (8) of the operating member (4).

10. Apparatus as claimed in claim 9, in which the virtual environment processor means (3) combines the image (2) of the interface with the image (8) of the operating member for the user.

11. Apparatus as claimed in any of claims 2 to 10, in which the virtual environment processor means (3) provides input signals for the device in accordance with the interaction of the operating member image (8) with the interface image (2).

12. Apparatus as claimed is any preceding claim including an application programming interface to allow application programs to operate on the device.

13. Apparatus as claimed in any of claims 2 to 12, in which the virtual environment processor means (3) provides output signals for an output display such as a monitor, TV or head-up display.

14. Apparatus as claimed in any of claims 2 to 12, in which the virtual environment processor means (3) generates output signals to control an external device.

15. A method of providing input signals to a device to be controlled by an operator comprising:
generating a virtual image (2) of an interface to the device to be controlled;
detecting the position of an operating member (4) actuated by the operator;
generating a virtual image (8) of the operating member (4);
relating the virtual image (8) of the operating member to the virtual image (2) of the interface such that movement of the operating member image (8) in accordance with movement of the operating member (4) interacts with the interface image (2); and
providing input signals for the device from the interaction of the operating member image and the interface image.

16. A method as claimed in claim 15, in which generation of the interface image (2) is performed by a virtual environment processor means (3).

17. A method as claimed in claim 15 or claim 16, in which detection of the position of the operating member is performed by a stereoscopic image generator (5).

18. A method as claimed in any of claims 15 to 17, in which generation of the operating member image (8) is performed by manipulation of the data by an image preparation means (6), by a signal generator (7), which generates signals indicating the three-dimensional co-ordinates of the operating member from the stereo data, and by the virtual environment processor means (3), using the three-dimensional co-ordinates.

19. A method as claimed in any of claims 15 to 18, in which relating the operating member image to the interface image is performed by the virtual environment processor means (3).

20. A method as claimed in any of claims 15 to 19, in which production of the input signals for the device is performed by the virtual environment processor means (3).

21. A method as claimed in any of claims 15 to 20, in which the virtual environment processor means (3) accepts signals from external devices or programs to enable these to be operated in the interface image (2).

22. A method as claimed in any of claims 15 to 21, in which the virtual environment processor means (3) provides output signals for the output display or to control external devices.

23. Apparatus for providing input signals to a device (1) to be controlled by an operator comprises means (5) for optically detecting the position of an operating member (4) actuated by the operator in a control space corresponding to an input device of the device to be controlled, movement of the operating member (4) in the control space being represented on an output device (20) and providing input signals for the device, characterised in that the means for detecting the position of the operating member comprises a stereoscopic image generator (5).

24. Apparatus as claimed in claim 23, in which the operating member (4) comprises the operator's hand.

25. Apparatus as claimed in claim 23, in which the operating member (4) comprises a tool such as a stylus or pointer adapted to be held in the hand or other part of the operator's body.

26. Apparatus as claimed in any of claims 23 to 25, in which the stereoscopic image generator (5) comprises a pair of pinhole cameras whose optical properties are known or can be calculated.

27. Apparatus as claimed in any of claims 23 to 26, in which the data from the stereoscopic pairs of images are passed to an image preparation means (6) to manipulate the stereo data.

28. Apparatus as claimed in claim 27, in which the image preparation means (6) passes the data to a signal generator (7), which generates signals indicating the three-dimensional co-ordinates of the operating member (4) using the stereo data.

29. Apparatus as claimed in claim 28, in which the signals from the signal generator (7) provide the input signals for the device to be controlled.

30. Apparatus as claimed in any of claims 23 to 28, in which movement of the operating member (4) in the control space provides the input signals to the device directly.

31. Apparatus as claimed in any of claims 23 to 30, in which the stereoscopic image generator (5), the image preparation means (6) and the signal generator (7) are combined in a single unit (21), separate from the device to be controlled.

32. Apparatus as claimed in claim 31, in which the input signals are relayed from the unit (21) to the device being controlled by wires (22), or infra-red or other appropriate wireless protocols.

33. Apparatus as claimed in any of claims 23 to 30, in which the stereoscopic image generator (5), the image preparation means (6) and the signal generator (7) are incorporated into the device to be controlled.

34. A method of providing input signals to a device to be controlled by an operator comprising:
defining a control space corresponding to an input device of the device to be controlled;
optically detecting by means of a stereoscopic image generator (5) the position of an operating member (4) actuated by the operator in the control space;
providing input signals for the device from the movement of the operating member (4) in the control space; and
representing movement of the operating member (4) in the control space on an output device (20) of the device to be controlled.

35. A method as claimed in claim 34, in which providing the input signals is performed by manipulation of the data by an image preparation means (5), and by a signal generator (6), which generates signals indicating the three-dimensional co-ordinates of the operating member from the stereo data.

36. A method as claimed in claim 34 or claim 35, in which representing the movement of the operating member (4) on the output device is performed as movement of a cursor on a display screen.
